(19) United States
(12) Patent Application Publication
(10) Pub. No.: US 2003/0085539 A1
(43) Pub. Date: May 8, 2003

(54) Space saving wheel mechanism for a sporting device

(76) Inventor: Jimmy Cochimin, Ft Wayne, IN (US)

Correspondence Address: BAKER & DANIELS, 300 NORTH MERIDIAN STREET, SUITE 2700, INDIANAPOLIS, IN, 46204-1782, US

(21) Appl. No.: 10/007,952

(22) Filed: Nov. 8, 2001

(51) Int. Cl. B62B 13/02

(52) U.S. Cl. 280/38; 280/639

(57) ABSTRACT

The present invention involves the rotational principle of rotatable arms, and the restoring force available from biasing elements, by way of intelligent construction of these components together with a structure body and the various standard components of a scooter, provides a simple yet very effective space saving method for a multiple wheeled scooter, or a sporting device. Accordingly, a multiple wheeled scooter, or a sporting device constructed according to the present invention will be more cost effective and more compact and portable for use as a carry-on transportation device. A space saving wheel mechanism according to the present invention includes a structure body, a wheel support, a wheel, a first rotatable arm and a second rotatable arm pivotably engaging the wheel support. At least one of the rotatable arms includes a pair of pivots adapted to rotate about a fixed pivot attached to the structure body. Rotation of the rotatable arms changing the distance between the wheel and the structure body. As a result, a multiple wheeled scooter or sporting device according to the present invention could save up to 35% of packaging space every stage of the way from manufacturing to end use when compared with that for any existing three wheeled scooter.

### BACKGROUND OF THE INVENTION

1. Field of the Invention

This invention relates to multiple wheeled sporting devices, such as a scooter, a skate, a skateboard or the like. Such multiple wheeled sporting devices can be used for sports, recreation and exercise use, as well as for transportation in selected areas. Although this invention is presented using portable collapsible scooters as illustrations, its application in wheeled skates, wheeled skateboards and similar multiple wheeled sporting devices is well understood and is within the scope of the present invention.

2. Description of the Related Art

Multiple wheeled portable sporting scooters are now well known in the art, though they have not been widely received as well as two wheeled sporting scooters. Some of the limitations of multiple wheeled scooters yet to be overcome are perceived stability, total weight, and overall size. At the present there are several three wheeled scooters available in the market. Although three wheeled scooters provide extra stability and maneuverability when compared with two wheeled scooters, overall size of three wheeled scooters is the biggest inherent obstacle keeping them from becoming more popular. Known multiple wheeled scooters, despite their compactness and fold-ability, still tend to be too bulky to allow for easy lifting and transporting. If a truly lightweight portable, safe, convenient and easily foldable multiple wheeled sporting scooter were available, it would certainly encourage more people to use such a device as a carry-on transportation device.

### SUMMARY OF THE INVENTION

The general purpose of the present invention is to provide a new and improved multiple wheeled scooter which has all the advantages of the prior art and is compact enough to be used mainly as a carry-on device for transportation use. The present space saving wheel mechanism invention is easy and safe to operate. Additionally, when the innovative scooter wheels are folded, it can be easily fit in a smaller space due to its compactness. The present space saving compact scooter's enhanced portability allows users to carry it on buses and trains and then to use it to travel the short distance often needed to complete a journey. The overall size is reduced by using a feature that permits the scooter wheels to be easily rotated between a folded position and an expended position. The functionality of such a multiple wheeled scooter is kept intact while its portability is greatly improved. A typical two wheeled scooter in a folded position takes up an average storage volume of 100 mm×200 mm×700 mm. A typical three wheeled scooter in a folded position takes up an average storage volume of 250 mm×200 mm×700 mm. That is 150% increase in shipping and storage space when compared with that for a two wheeled scooter. Quite to the contrary, a typical multiple wheeled scooter according to the present invention will only take up approximately 150 mm×200 mm×750 mm. That is only 50% increase in shipping and storage space when compared with that for a two wheeled scooter. Thus a typical multiple wheeled scooter according to the present invention could save up to 35% of packaging space every stage of the way from manufacturing to end use when compared with that for an existing three wheeled scooter.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a layout wire frame side view of a multiple wheeled sporting device in a folded position according to the present invention.

FIG. 2 is a layout wire frame side view of a multiple wheeled sporting device in a expanded position according to the present invention.

FIG. 3 is a top view of a space saving wheel mechanism attached to a structure body shown in a folded position.

FIG. 4 is a side view of a space saving wheel mechanism attached to a structure body shown in a folded position.

FIG. 5 is a top view of a space saving wheel mechanism attached to a structure body shown in an expanded position.

FIG. 6 is a side view of a space saving wheel mechanism attached to a structure body shown in an expanded position.

FIG. 7 is a top view of a space saving wheel mechanism without the structure body shown in a folded position with the wheels parallel to the rotatable arms.

FIG. 8 is a top view of a space saving wheel mechanism without the structure body shown in an expanded position with the wheels perpendicular to the rotatable arms.

FIG. 9 is a top view of a space saving wheel mechanism without the structure body shown in an expanded position with the wheels rotated at an angle.

FIG. 10 is a top view of a space saving wheel mechanism without the structure body shown in a folded position with the wheels parallel to the rotatable arms, and an alternative construction method for a biasing element.

FIG. 11 is a top view of a space saving wheel mechanism without the structure body shown in an expanded position with the wheels perpendicular to the rotatable arms, and an alternative construction method for a biasing element.

FIG. 12 is a top view of a space saving wheel mechanism without the structure body shown in an expanded position with the wheels rotated at an angle, and an alternative construction method for a biasing element.

FIG. 13 is a top view of a space saving wheel mechanism without the structure body shown in a folded position with the wheels parallel to the rotatable arms, and the two wheels and corresponding rotatable arms are asymmetrical.

FIG. 14 is a top view of a space saving wheel mechanism without the structure body shown in an expanded position with the wheels perpendicular to the rotatable arms, and the two wheels are symmetrical while the corresponding rotatable arms are asymmetrical.

FIG. 15 is a top view of an alternative space saving wheel mechanism without the structure body shown in a folded position with the wheels parallel to the rotatable arms both of which are constrained to rotate about fixed axes.

FIG. 16 is a top view of an alternative space saving wheel mechanism without the structure body shown in an expanded position with the wheels perpendicular to the rotatable arms which are constrained to rotate about fixed axes.

FIG. 17 is a top view of an alternative space saving wheel mechanism without the structure body shown in a folded position with the wheels parallel to the rotatable arms, only one of which are arranged to rotate about a fixed axis.

FIG. 18 is a top view of an alternative space saving wheel mechanism without the structure body shown in an expanded position with the wheels perpendicular to the rotatable arms, only one of which are arranged to rotate about a fixed axis.

FIG. 19 is a top view of an alternative space saving wheel mechanism without the structure body shown in an expanded position with the wheels rotated at an angle, and only one of the rotatable arms is arranged to rotate about a fixed axis.

Corresponding reference characters indicate corresponding parts throughout the several views. Although the drawings represent embodiments of the present invention, the drawings are not necessary to scale and certain features may be exaggerated in order to better illustrate and explain the present invention. The exemplification set out herein illustrates an embodiment of the invention, in one form, and such exemplification are not to be construed as limiting the scope of the invention in nay manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings. It is understood that each and every component shown herein is a three dimensional object and has a thickness of finite dimension, though the drawings are plane views without revealing the other sides of any three dimensional object.

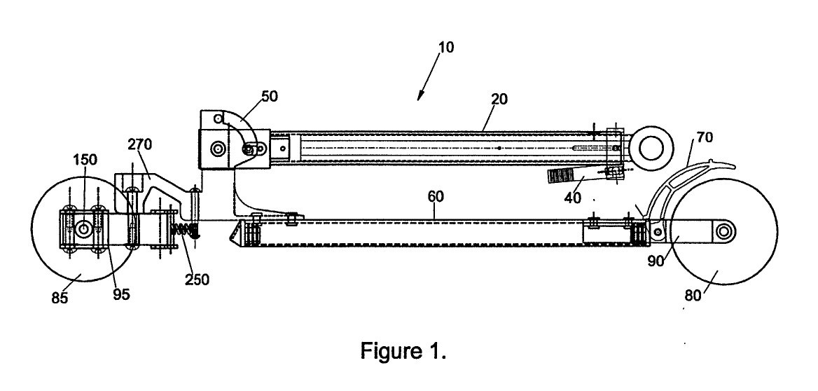

As shown in FIG. 1 a multiple wheeled sporting device in a folded position according to the present invention includes a handle bar 20, a quick release clamp 40, a folder 50, a brake 70, a rear wheel 80, a rear wheel support 90, a platform 60, a structure body 270, a biasing element 250, a front wheel 85, a front wheel support 95, and a wheel axle 150. Other components will be described in the following paragraphs.

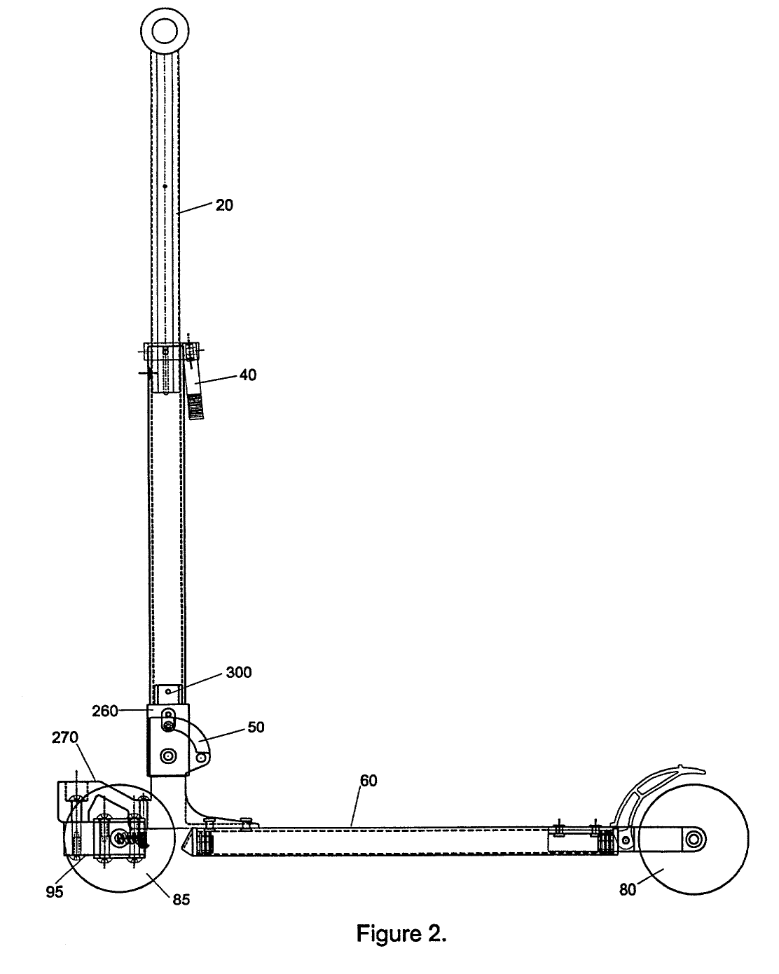

As shown in FIG. 2. a multiple wheeled sporting device in a expanded position according to the present invention has the front wheels expanded and are located at the two sides of the platform. The overall dimension and functionality is comparable with that of a typical three wheeled scooter without any sacrifice.

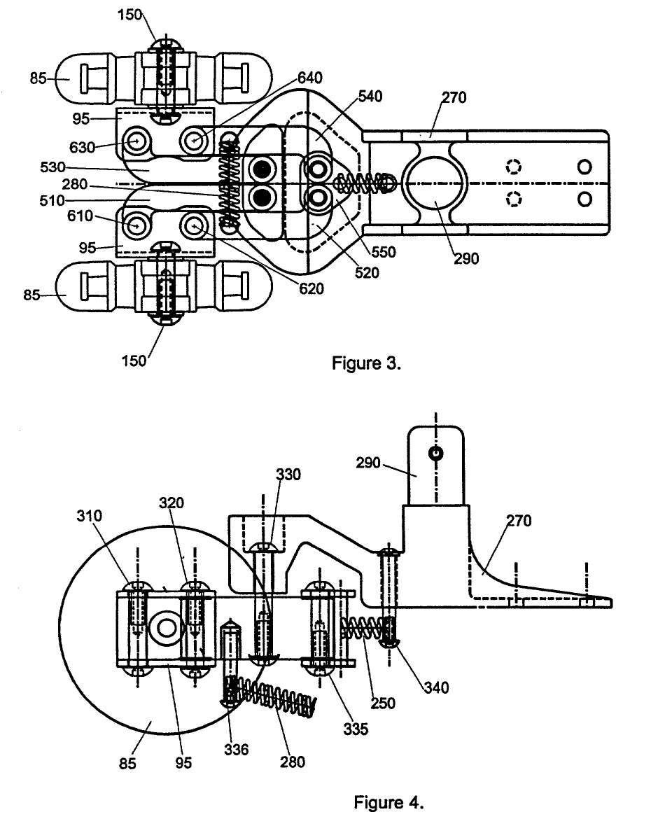

As shown in FIG. 3 and FIG. 4 a space saving wheel mechanism attached to a structure body shown in a folded position includes a pair of axles 150, two pairs of rotatable arms 510, 520, and 530, 540, wheels 85, wheel supports 95, a biasing element 280 connecting two of the rotatable arms, another biasing element 250 connecting a floater 550 to the structure body 270. Also shown is a post like member off the structure body adapted to receive the handle bar assembly through the folder mechanism.

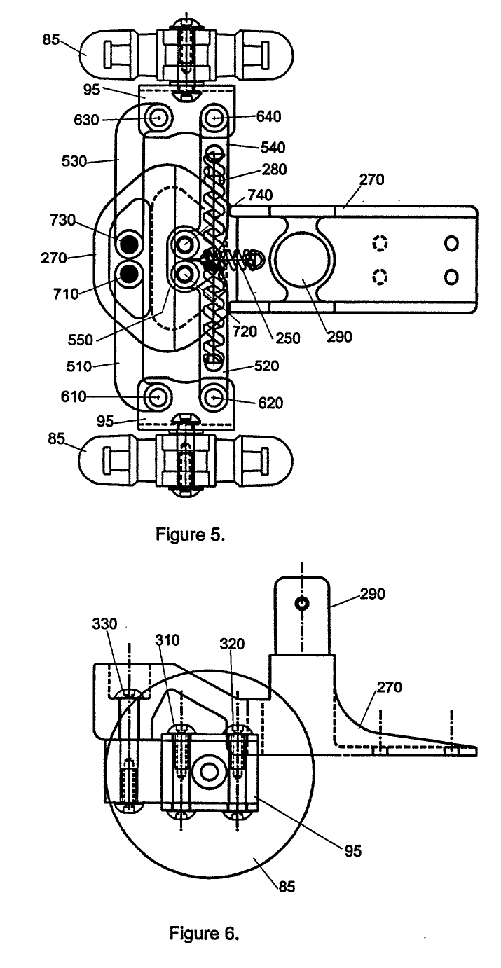

As shown in FIG. 5 and FIG. 6 a space saving wheel mechanism attached to a structure body shown in an expanded position have the wheels shown perpendicular to the rotatable arms. The width dimension from one side of the wheel to the other side of the other wheel is generally in the range of 200 mm to 250 mm wide.

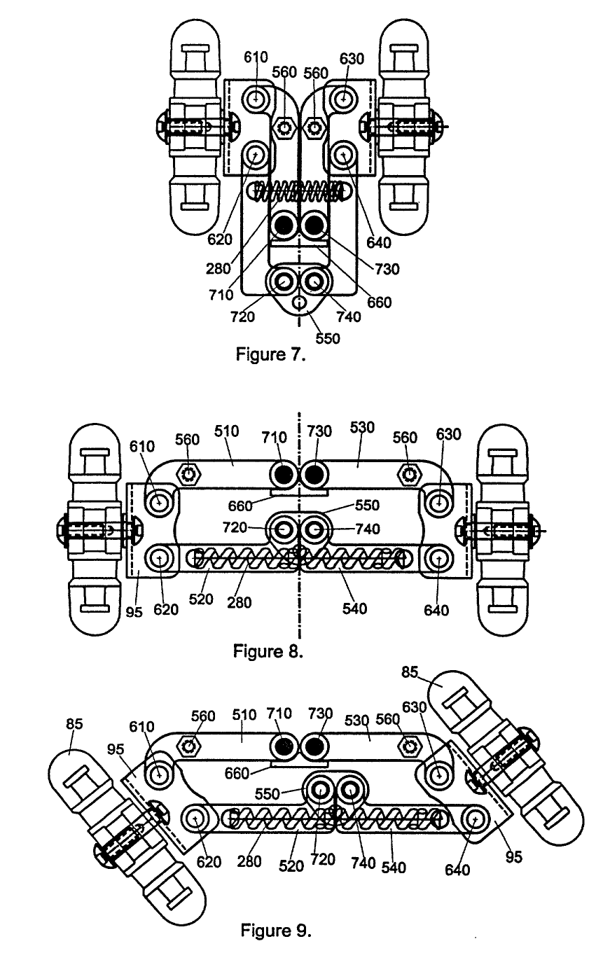

As shown in FIG. 7, FIG. 8 and FIG. 9 a space saving wheel mechanism without the structure body shown with a floater 550 connecting pivot 720 and pivot 740 of rotatable arm 520 and arm 540. Thus the two arms are arranged to move together. A biasing element 280 was shown connecting arm 520 and arm 540. Pivots 710 and 730 are fixedly attached to the structure body which is not explicitly shown. Pivots 610, 620, 630, 640 are pivotably engaged with the wheel supports 95. Fasteners 560 are capable of locking the rotatable arms 510 and 530 in either the folded position or the expanded position. The biasing element 280 serves to close the arms and hold them together in the folded position, and to hold the same arms expanded while in the expanded position. The floater 550 allows the wheels to turn with respect to arms 510 and 530 which are held stationary against a stopper 660. The stopper limits the acceptable rotation span of the arms 510 and 530 to something less than one hundred and eighty degrees.

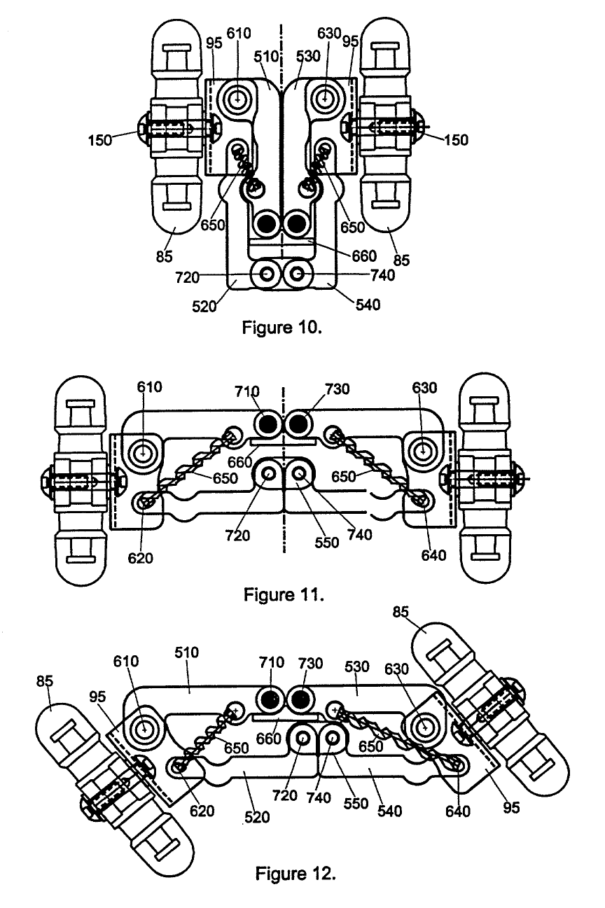

As shown in FIG. 10, FIG. 11 and FIG. 12 these are the same space saving wheel mechanism without the structure body as that in FIGS. 7, 8 and 9 except an alternative construction method for a biasing element. In this illustration one biasing elements is used to connect between the first rotatable arm 510 and the second rotatable arm 520, while another biasing elements is used to connect between the third rotatable arm 530 and the forth rotatable arm 540. Pivots 610, 620, 630 and 640 are adapted to engage the wheel supports allowing the wheels to rotate with the rotatable arms. Pivots 710 and 730 are fixedly attached to the structure body. Pivots 720 and 740 are floating and free to move together with the floater 550. The inclination angle of the biasing elements 280 in the folded position can be calculated so that they will exert a positive closure force to keep the rotatable arms together.

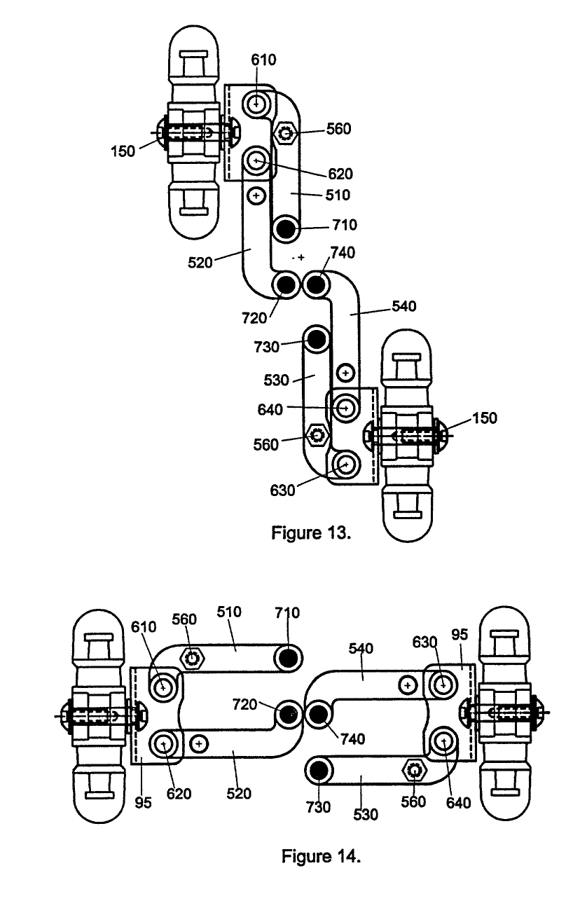

Shown in FIG. 13 is a space saving wheel mechanism without the structure body 270 shown in a folded position with the wheels parallel to the rotatable arms 510, 520, 530, 540, and the two wheels 85 and corresponding rotatable arms are asymmetrical. Such an arrangement presents an alternative construction where the wheels are not free to turn except through the control of a handle bar 20 pivotably connected to the structure body. FIG. 14 shows the same construction in an expanded position.

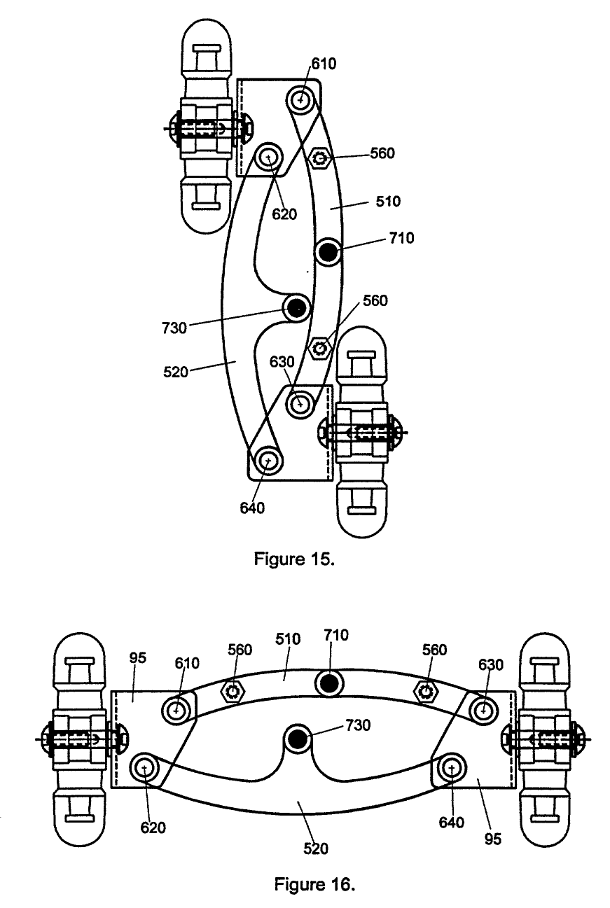

Shown in FIG. 15 is a space saving wheel mechanism without the structure body shown in a folded position with the wheels parallel to the rotatable arms and both of which are constrained to rotate about fixed axes. Such an arrangement presents also an alternative construction where wheels are not free to turn except through the control of a handle bar pivotably connected to the structure body. FIG. 16 shows the same construction in an expanded position.

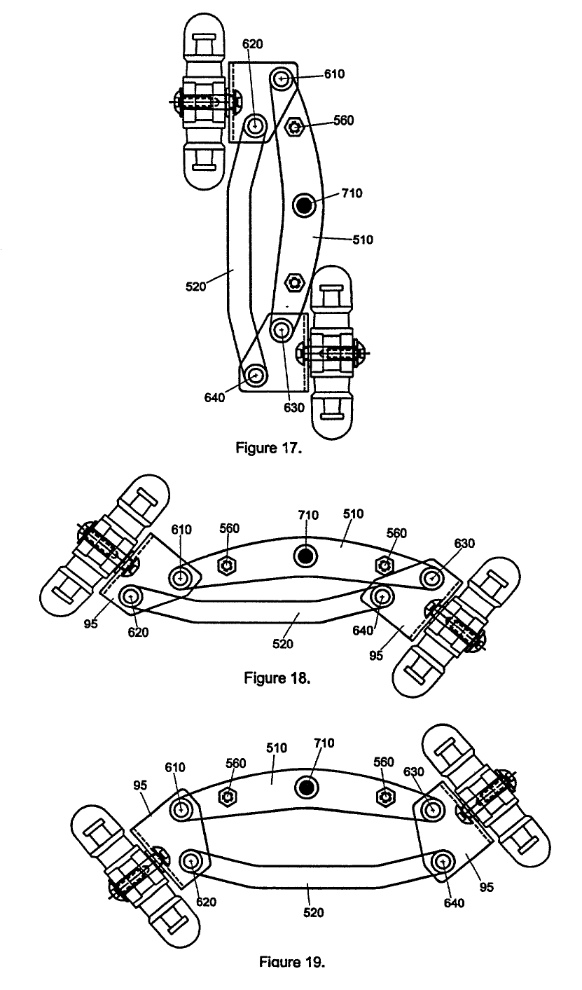

Shown in FIG. 17 is a space saving wheel mechanism without the structure body shown in a folded position with the wheels parallel to the rotatable arms and only one of which are constrained to rotate about a fixed axis. Such an arrangement presents yet another alternative construction where the wheels are again free to turn. FIG. 18 and FIG. 19 shows the same construction in an expanded and rotated position.

The present invention uses the rotational principle of rotatable arms, and the restoring force available from biasing elements, by way of intelligent construction of these components together with a structure body and the various standard components of a scooter, provides a simple yet very effective space saving method for a multiple wheeled scooter. A multiple wheeled scooter according to the present invention could save up to 35% of packaging space every stage of the way from manufacturing to end use when compared with that for an existing three wheeled scooter. Accordingly, a multiple wheeled scooter constructed according to the present invention will be more cost effective and more compact and portable as a carry-on transportation device.

Although this invention is presented using portable collapsible scooters as illustrations, its application in wheeled skates, wheeled skateboards and similar multiple wheeled sporting devices is well understood and is within the scope of the present invention. While this invention has been described as having an exemplary design, the present invention may be further modified within the spirit of this disclosure. This application is therefore intended to cover any variations, uses, or adaptations of the invention using its general principles. Further, this application is intended to cover such departures from the present disclosure as come within known or customary practice in the art to which the present invention pertains.

What is claimed is:

1. A space saving wheel mechanism for a sporting device comprising:
a structure body,
a wheel support,
said wheel support supporting a wheel,
a first rotatable arm and a second rotatable arm,
each of said the first and the second rotatable arms pivotably engaging said wheel support, and each including a pair of pivots,
said first rotatable arm arranged to rotate about a fixed pivot attached to said structure body,
rotation of said first rotatable arm changing the distance between said wheel and said structure body.

2. A space saving wheel mechanism for a sporting device according to claim 1, characterized by:
the second rotatable arm also arranged to rotate about a second fixed pivot attached to said structure body.

3. A space saving wheel mechanism for a sporting device according to claim 1, characterized by:
another wheel supported by another wheel support pivotably engaging the first rotatable arm and the second rotatable arm.

4. A space saving wheel mechanism for a sporting device according to claim 1, characterized by:
another wheel supported by another wheel support pivotably engaging a third rotatable arm and a fourth rotatable arm.

5. A space saving wheel mechanism for a sporting device according to claim 1, characterized by:
a biasing element biased toward restoring said rotatable arms to a predefined position.

6. A space saving wheel mechanism for a sporting device according to claim 4, characterized by:
a floater pivotably connecting two of said rotatable arms allowing the connected pivots to move together.

7. A space saving wheel mechanism for a sporting device according to claim 4, characterized by:
the center lines of the wheel axles are approximately in-line with each other.

8. A space saving wheel mechanism for a sporting device according to claim 3, characterized by:
the axles of the wheels are off set from each other.

9. A space saving wheel mechanism for a sporting device according to claim 2, characterized by:
another wheel supported by another wheel support pivotably engaging the first rotatable arm and the second rotatable arm.

10. A space saving wheel mechanism for a sporting device according to claim 1, characterized by:
a stopper engaging one of said rotatable arms limiting its span of rotation to something less than one hundred and eighty degrees.

11. A space saving wheel mechanism for a sporting device according to claim 1, characterized by:
a folder connecting a handle bar and a platform, said platform adapted to support the weight of an operator.
